(19) United States
(12) Patent Application Publication
(10) Pub. No.: US 2025/0131255 A1
(43) Pub. Date: Apr. 24, 2025

(54) SIGNAL PROCESSING METHOD IN A NEURAL NETWORK

(71) Applicant: UNIVERSITÄT BERN, Bern (CH)

(72) Inventors: Mihai A. PETROVICI, Bern (CH); Walter M. SENN, Bern (CH); Jakob J. JORDAN, Bern (CH); Paul HAIDER, Bern (CH); Benjamin ELLENBERGER, Spiez (CH); Laura M. KRIENER, Zurich (CH)

(21) Appl. No.: 18/693,440

(22) PCT Filed: Sep. 11, 2022
(86) PCT No.: PCT/EP2022/075196

§ 371 Date: Mar. 19, 2024

(30) Foreign Application Priority Data
Sep. 25, 2021 (EP) 21199018.9

(51) Int. Cl. G06N 3/063

(52) U.S. Cl. CPC G06N 3/063

(57) ABSTRACT

The present invention concerns a method of processing signals in a neural network comprising a set of neurons interconnected by a set of synapses, with each neuron comprising a soma and a set of apical and/or basal dendrites. According to an embodiment, the method comprises: updating at least one synaptic input signal configured to be received at input nodes of one or more neurons; updating the corresponding basal potential of at least one of the basal dendrites; updating the corresponding apical potential of at least one of the apical dendrites; updating a potential differential for at least one neuron by using at least the updated apical and basal potentials; updating the somatic potential of at least one of the somas by using at least the corresponding updated potential differentials; updating the prospective potential of at least one neuron by using at least the corresponding updated somatic potentials and potential differentials; and generating a neuronal output signal for at least one neuron by using the corresponding updated prospective potentials. The method may further comprise updating prospective and/or membrane time constants, as well as synaptic weights for a subset of neurons using a subset of the above-mentioned variables.

### FIELD OF THE INVENTION

The present invention relates to a signal processing method in a neural network. The teachings of the present invention may be used to implement fast computation in physical substrates with slow components. The present invention also relates to a computer program product comprising instructions for implementing the steps of the method, as well as to a neural network configured to carry out the proposed method.

### BACKGROUND OF THE INVENTION

Physical systems composed of large collections of simple, but intricately connected elements can exhibit powerful collective computational properties. Animals' nervous systems, and most prominently the human brain are prime examples. Its computational prowess has motivated a large, cross-disciplinary and ongoing endeavour to emulate aspects of its structure and dynamics in artificial substrates, with the aim of being ultimately able to replicate its function. The speed of information processing in such a system depends on the response time of its components; for neurons, for example, it can be the integration time scale determined by their membrane time constant.

If we consider hierarchically organised neural networks composed of such elements, each layer in the hierarchy causes a response lag with respect to a changing stimulus. This lag introduces two related critical issues. For one, the inference speed in these systems decreases with their depth. This in turn induces timing mismatches between instructive signals and neural activity, which disrupts learning. For example, recent proposals for bio-plausible implementations of error backpropagation (BP) in the brain require some form of relaxation, both for inference and during learning. Notably, this also affects some purely algorithmic methods involving auxiliary variables. To deal with this inherent property of physical dynamical systems, two approaches have been suggested: either phased plasticity that is active only following a certain relaxation period, or long stimulus presentation times with small learning rates. Both of these solutions entail significant drawbacks: the former is challenging to implement in asynchronous, distributed systems, such as cortical networks or neuromorphic hardware, while the latter results, by construction, in slow learning. This has prompted the critique that any algorithm requiring such a settling process is too slow to describe complex brain function, particularly when involving real-time responses. To the best of our knowledge this fundamental problem affects all modern models of approximate BP in biological substrates.

### BRIEF DESCRIPTION OF THE INVENTION

The present invention aims to overcome at least some of the above-identified problems. More specifically, to overcome the above problems, it proposes a novel signal processing framework in neural networks that allows fast computation and learning in physical substrates with slow components.

According to a first aspect of the invention, a method of processing signals in a neural network is provided, as recited in claim 1.

The speed of information processing in physical systems depends crucially on the reaction speed of their microscopic components; for example, springs need time to decompress, or capacitors need time to charge. In analogue neuronal networks, both biological and bio-inspired/neuromorphic, neurons (which operate similarly to capacitors) need time to accumulate and react to stimuli. In many information processing scenarios, such as deep neuronal networks, input needs multiple stages of processing. This is usually achieved by consecutive layers of neurons, so at every stage of processing, the delays induced by “slow” neurons accumulate. This slows down inference and, much more problematically, disrupts learning. The present invention provides a framework that effectively alleviates this problem. We can endow neurons with a mechanism that speeds up their reaction by guessing their future state at any point in time. In principle, this allows arbitrarily slow neurons to respond arbitrarily quickly to inputs, making local information processing effectively instantaneous.

Note that we differentiate explicitly between the processing/computation speed of individual units (or neurons) and the communication speed between them. Our proposed method refers to the former. The latter is always finite and constrained by physics, i.e. by the speed with which signals can travel between units, which is ultimately limited by the speed of light.

In addition to the above-mentioned mechanism, two additional components are developed according to the present invention. The first one is a full microscopic (i.e., at the level of individual neurons and synapses) realisation of inference and learning using a network structure inspired by cortex that is amenable to extremely efficient implementation in neuromorphic hardware. The second is a way to alleviate the effects of substrate variability and temporal noise in analogue circuits by neuronal adaptation and synaptic filtering; both of these are local computations carried out by simple components. Such robustness to spatiotemporal noise is an important prerequisite for a viable realisation in silico.

The proposed solution also provides a biologically plausible approximation of BP in deep cortical networks with continuous-time, leaky neuronal dynamics and local, continuous plasticity. Moreover, the proposed model is easy to implement in both software and hardware and is well-suited for distributed, asynchronous systems.

In the proposed framework, inference can be arbitrarily fast (up to finite simulation resolution or finite communication speed across physical distances) despite a finite response time of individual system components; downstream responses to input changes thus become effectively instantaneous. Conversely, responses to instructive top-down input that generate local error signals are also near-instantaneous, thus effectively removing the need for any relaxation phase. This allows truly phase-free learning from signals that change on much faster time scales than the response speed of individual network components. Similarly to some other approaches, the present method derives neuron and synapse dynamics from a joint energy function. However, the energy function according to the present invention is designed to effectively disentangle these dynamics, thus removing the disruptive co-dependencies that otherwise arise during relaxation. This is achieved by introducing the simple, but important new ingredient: neuronal outputs that try to predict their future state based on their current information, a property that in the present description is described as “prospective”. Thereby, the proposed framework also constructs an intimate relationship between such “slow” neuronal networks and artificial neural network (ANN), thus enabling the application of various auxiliary methods from deep learning. To differentiate between biologically plausible, leaky neurons and abstract neurons with instantaneous response, we respectively use the terms “neuronal” and “neural”.

According to a second aspect of the invention, a computer program product is provided, comprising instructions for implementing the steps of the method according to the first aspect of the present invention when loaded and run on the computing means of an electronic device.

According to a third aspect of the invention, a neural network is provided, which is configured to implement the method according to the first aspect of the present invention.

Other aspects of the invention are recited in the dependent claims attached hereto.

### BRIEF DESCRIPTION OF THE DRAWINGS

The invention will now be described in more detail with reference to the attached drawings, in which:

FIG. 1 schematically illustrates a neuron structure;

FIG. 2a shows a simple, functionally feedforward network of two neurons, illustrating also the recurrence induced by the propagation of both bottom-up signals and top-down errors;

FIG. 2b shows graphs illustrating neuronal firing rates (rᵢₙ, r₁, r₂) and membrane potentials (u₁, u₂) for an input sequence consisting of a quickly but smoothly changing stimulus followed by two constant stimuli, where dashed black lines denote instantaneous (relaxed) rates, while grey shading highlights the mismatch between instantaneous and actual firing rates that disrupts both inference and learning;

FIG. 2c illustrates continuous learning during relaxation without prospective coding in the network shown in FIG. 2a, where the dotted black line in the upper graph shows the target membrane potential, and solid lines show trajectories for vanishing learning rates, while dashed lines show trajectories for nonzero learning rates (note the overshoot when learning is continuously active); in the bottom graph presynaptic weights of 1st/2nd neuron are shown;

FIG. 2d shows the same graphs as in FIG. 2b, but when the teachings of the present invention have been applied, note the instantaneous reaction to input changes of the second neuron;

FIG. 3 shows a schematic of a cortical network model on the left side, and a more detailed view of a cortical microcircuit on the right side consisting of two pyramidal cells and one interneuron;

FIGS. 4a and 4b show a flowchart illustrating the operation of an example artificial neural network according to the present invention;

FIG. 5 shows two pyramidal cells and one interneuron in a cortical microcircuit;

FIGS. 6a and 6b show a flowchart illustrating the operation of an example cortical microcircuit according to the present invention;

FIG. 7 shows a graph for an example where the teachings of the present invention are applied to a network of harmonic oscillations; and

FIG. 8 shows a graph demonstrating temporal processing capabilities of the present invention.

### DETAILED DESCRIPTION OF THE INVENTION

It should be noted that the figures are provided merely as an aid to understanding the principles underlying the invention, and should not be taken as limiting the scope of protection sought. Where the same reference numbers are used in different figures, these are intended to indicate similar or corresponding features. It should not be assumed, however, that the use of different reference numbers is intended to indicate any particular degree of difference between the features to which they refer. As used herein, unless otherwise specified the use of the ordinal adjectives “first”, “second”, “third”, etc. to describe a common object, merely indicate that different instances of like or different objects are being referred to, and are not intended to imply that the objects so described must be in a given sequence, either temporally, spatially, in ranking, or in any other manner.

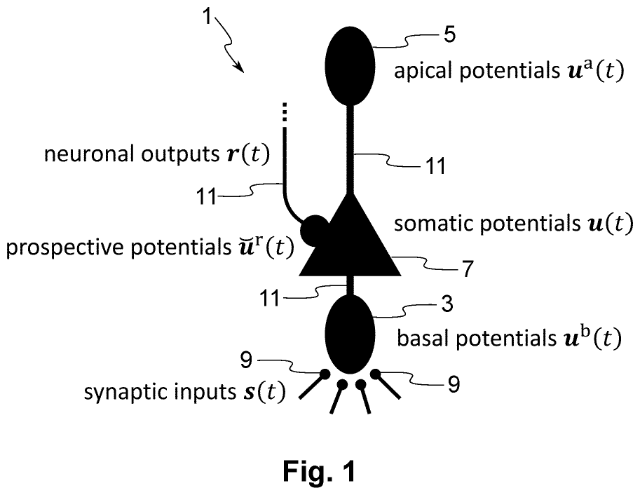

The teachings of the present invention may be implemented in a neural network comprising a set of neurons. An example neuron structure is illustrated in FIG. 1. The neuron 1 as shown in FIG. 1 consists of three compartments, namely a first compartment 3, which in in this example is a basal dendrite, a second compartment 5, which in this example is an apical dendrite, and a third compartment 7, which in this example is a somatic compartment, and which is configured to integrate dendritic information and to generate the neuronal output signal r(t). In operation, the basal dendrite is characterised by its basal potential u^{b}(t), the apical dendrite is characterised by its apical potential u^{a}(t), and the somatic compartment is characterised by its somatic potential u(t). As explained later in more detail, according to the present invention the neuron can be characterised by its prospective potential ǔ^{r}(t). In this example, the basal dendrite is configured to receive synaptic input signal s(t) through synapses 9, which are characterised by their weights w. The first, second and third compartments are connected to each other by transmission lines 11 as shown in FIG. 1.

### Problems of Slow Components

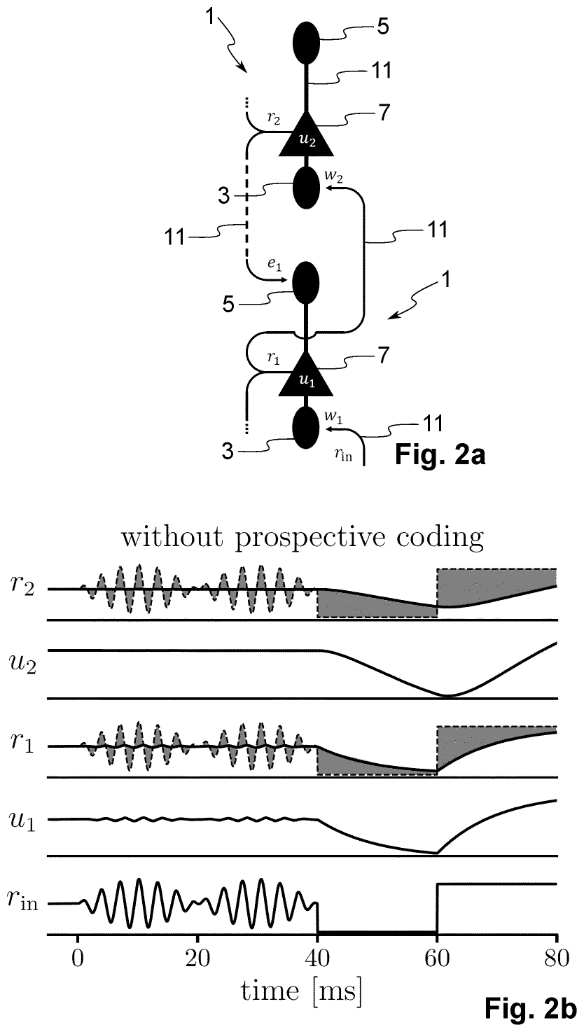

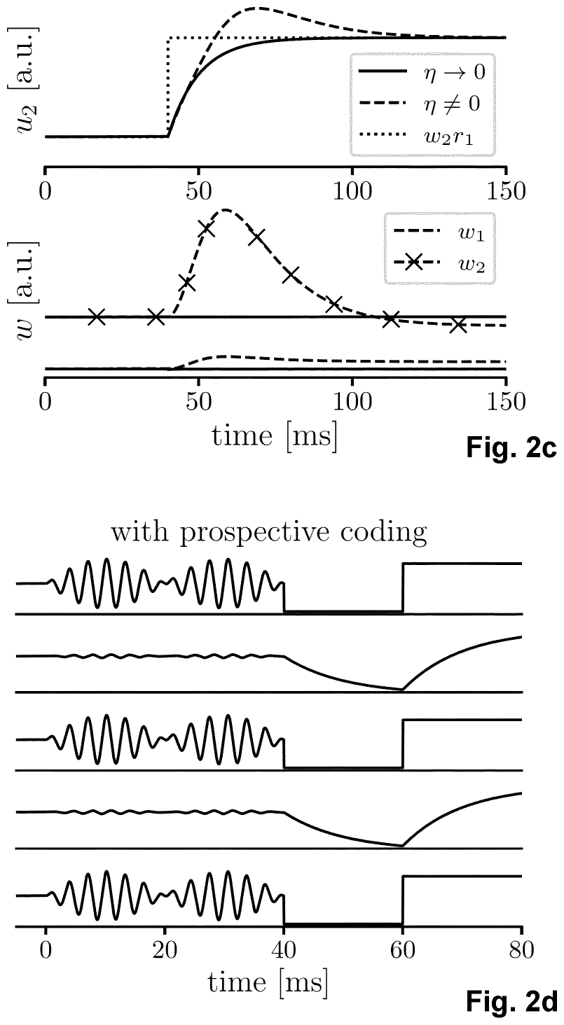

To illustrate the issue with relaxation, we consider a simple network of two model neurons arranged in a chain as shown in FIG. 2a. Biological neuronal membrane potentials u are conventionally modelled as leaky integrators of their input I:Cₘ\dot{u}=−gₗu−I, where the membrane capacitance Cₘ and leak conductance gₗ determine the membrane time constant τ^{m}:=Cₘ/gₗ and thereby its response speed. These dynamics attenuate and delay input, resulting in significant differences between neuronal output rates and those expected in an instantaneous system (FIG. 2b). This mismatch increases with every additional layer; a feedforward network with n layers thus has an effective relaxation time constant of approximately nτ^{m}.

Besides slow inference, this delayed response leads to critical issues during learning from downstream instructive signals. Consider the typical scenario where such a target signal is present in the output layer and plasticity is continuously active (and not phased according to some complicated schedule). If the system fulfils its task correctly, the target signal corresponds to the output of the relaxed system and no learning should take place. However, due to delays in neuronal responses, the output signal differs from the target during relaxation, which causes plasticity to adapt synaptic weights in an effort to better match the target. As a result, the system “overshoots” during early relaxation and has to undo these synaptic changes through further learning in the late relaxation phase (FIG. 2c). Also, since output errors need inputs to propagate forward through the entire network before propagating backwards themselves, the input layer only observes correct errors after about 2 nτ^{m}. This issue is referred to as the “relaxation problem”. In the following, a solution is presented for this problem, combining prospective neuron dynamics with continuously active, local synaptic plasticity.

### Fast Computations in Slow Substrates

Inspired by the canonical coordinates from classical mechanics, we describe the state of a neuronal network by its position in phase space (u, \dot{u}), with the generalised position u and the generalised momentum \dot{u}. The relation between these two components describes the physics of the system. To obtain the leaky integrator dynamics that characterise biological neurons, we first define the abstract network state ǔ^{m} as

$${{u}^{⋁}}^{m} := u + {τ}^{m} \dot{u} . \qquad ( 1 )$$

We next define an energy function E that characterises this state:

$$E ( {{u}^{⋁}}^{m} ) := \frac{1}{2} {‖ {{u}^{⋁}}^{m} - W φ ( {{u}^{⋁}}^{m} ) - b ‖}^{2} + βℒ ( {{u}^{⋁}}^{m} ) . \qquad ( 2 )$$

This energy represents a global view of the network from which neuron and weight dynamics will be derived. Here, W and b represent the weight matrix and bias vector, respectively, φ is the neuronal activation function and the loss [symbol] is scaled by a constant β. Bold font is used for matrices, vectors, and vector-valued functions. This formulation of the energy function is very generic and can, by appropriate choice of parameters, apply to different network topologies, including multilayer perceptrons, convolutional or recurrent networks. It is to be noted that this energy can be written as a neuron-wise sum over mismatch energies

$${E}_{i} ( {{u}^{⋁}}_{i}^{m} , {r}_{i , pre} ) = \frac{1}{2} {( {{u}^{⋁}}_{i}^{m} - {W}_{i} {r}_{i , pre} - {b}_{i} )}^{2} ,$$

where r_{i,pre}:=φ(ǔ_{i,pre}^{m}) is the presynaptic input vector for the ith neuron in the network.

We can now derive neuronal dynamics as extrema of the energy function from Equation 2:

$${∇}_{{{u}^{⋁}}^{m}} E = 0 ⇒ {τ}^{m} \dot{u} = - u + W φ ( {{u}^{⋁}}^{m} ) + b + e , \qquad ( 3 )$$

with presynaptic bottom-up input Wφ(ǔ^{m}) and top-down error signals

$$e = {φ}^{′} ( {{u}^{⋁}}^{m} ) {W}^{T} [ {{u}^{⋁}}^{m} - W φ ( {{u}^{⋁}}^{m} ) - b ] \qquad ( 4 )$$

for hidden neurons, and e=−B∇_{ǔ}_{^{m}} [symbol] for neurons which directly contribute to the loss. Using Equation 3, it is easy to see that in hierarchical networks these errors can be expressed recursively over layers [symbol] , [symbol] thus instantiating a variant of BP. Equation 3 can be interpreted as the dynamics of a structured pyramidal neuron receiving presynaptic, bottom-up input via its basal dendrites and top-down input via its apical tree. We later provide a more detailed description of our model's biophysical implementation. We note that the proposed approach contrasts with previous work that introduced neuron dynamics via gradient descent on an energy function. Indeed, this difference is crucial for solving the relaxation problem, as discussed below. Since for a given input our network moves, by construction, within a constant-energy manifold, we refer to our model as latent equilibrium (LE).

We can now revisit our choice of ǔ^{m} from a functional point of view. Instead of the classical output rate φ(u), our neurons fire with φ(ǔ^{m}), which depends on both u and \dot{u} (Equation 1). This represents a known, though often neglected feature of biological neurons and has also been considered in other models of bio-plausible BP derived from a stationary action. As neuron membranes are low-pass filters (Equation 3), ǔ^{m} can be viewed as a prospective version of u: when firing, the neuron tries to look into the future and predict the state of its membrane potential after relaxation. The prospective nature of ǔ^{m} also holds in a strict mathematical sense: the breve operator ̆^{m}:=(1+τ^{m}d/dt) is the exact inverse of an exponential low-pass filter. While neuronal membranes continue to relax slowly towards their steady states, neuronal outputs use membrane momenta to compute a correct instantaneous reaction to their inputs, even in the case of jumps (FIG. 2d). Thus, information can propagate instantaneously throughout the network, similarly to an ANN, counterintuitively even when membrane dynamics are never in equilibrium. The activity of the output layer hence reflects arbitrarily fast changes in the input-even on time scales smaller than the neuronal time constant τ^{m}—rather than responding with a significant time lag and attenuation as in previous, gradient-based models.

It is to be noted that, even for functionally feedforward networks, our resulting network structure is recurrent, with backward coupling induced by error inputs to the apical tree. As a non-linear recurrent network, it cannot settle instantaneously into the correct state; rather, in numerical simulations, it jumps quickly towards an estimated stationary activity state and reaches equilibrium within several such jumps (of infinitesimal duration). In practice, saturating activation functions can help avoid pathological behaviour under strong coupling. Moreover, we can introduce a very short exponential low-pass filter τ^{s} on top-down signals, slightly larger than the temporal resolution of the simulation. Thus, in physical systems operating in continuous time, τ^{s} can effectively become infinitesimal as well and does not affect the speed of information propagation through the network. In particular, as explained below, the perpetual consistency between input and output allows our model to continuously learn to reduce the loss, obviating the need for network relaxation phases and the associated global control of precisely timed plasticity mechanisms.

### Fast Learning in Slow Substrates

Based on our prospective energy function (Equation 2), we define synaptic weight dynamics, i.e., learning, as time-continuous stochastic gradient descent with learning rate η_{W}:

$$\dot{W} ∝ - {∇}_{W} E ⇒ \dot{W} = {η}_{W} [ {{u}^{⋁}}^{m} - Wr - b ] {r}^{T} . \qquad ( 5 )$$

Thus, weights evolve continuously in time driven by local error signals without requiring any particular schedule. Neuronal biases are adapted according to the same principle. It is to be noted that this rule only uses quantities that are available at the locus of the synapse (as also explained later). Intuitively, this locality is enabled by the recurrent nature of the network: errors in the output units spread throughout the system, attributing credit locally through changes in neuronal membrane potentials. These changes are then used by synapses to update their weight in order to reduce the network loss. However, our learning rule is not an exact replica of BP, although it does approximate it in the limit of infinitely weak supervision β→0 (often referred to as “nudging”); strictly speaking, it minimises the energy function E, which implicitly minimises the loss [symbol] . This form of credit assignment can be related to previous models which similarly avoid a separate artificial backward pass (as necessary in classical BP) by allowing errors to influence neuronal activity. Plasticity in the weights projecting to output neurons depends on the choice of [symbol] ; for example, for an L² loss, plasticity in the output layer corresponds to the classical delta rule: \dot{W}_{N}=−ηβ[r*_{N}−r_{N}]r_{N-1}^{T}.

Despite similarities to previous work, learning in our framework does not suffer from many of the shortcomings noted above. Since activity propagates quasi-instantaneously throughout the network, our plasticity can be continuously active without disrupting learning performance. This is true by construction and most easily visualised for a sequence of (piecewise constant) input patterns: following a change in the input, membrane dynamics take place in a constant-energy manifold (Equation 3) across which synaptic weight dynamics remain unchanged, i.e., they equally and simultaneously pull downwards on all points of this manifold. This disentangling of membrane and synaptic weight dynamics constitutes an important difference to previous work, where the neuronal mismatch energies Eᵢ change as dynamics evolve and thus cannot represent the true errors in the network before reaching a fixed point. We further note that LE also alleviates a second form of catastrophic forgetting in these other models: due to the misrepresentation of errors during relaxation, continuous learning changes synaptic weights even in perfectly trained networks (FIG. 2c).

### Fast Computation and Learning in Cortical Microcircuits

An example physical implementation of the proposed system is explained in the following. Due to the simplicity of their implementation, the principles of LE can be applied to models of approximate BP in the brain in order to alleviate the issues discussed above. Here we demonstrate how a network of hierarchically organised dendritic microcircuits can make use of our theoretical advances to significantly increase both inference and training speed, thus removing several critical shortcomings towards its viability as a scalable model of cortical processing. The resulting dynamical system represents a detailed and biologically plausible version of BP, with real-time dynamics, and phase-free, continual local learning able to operate on effectively arbitrary sensory timescales.

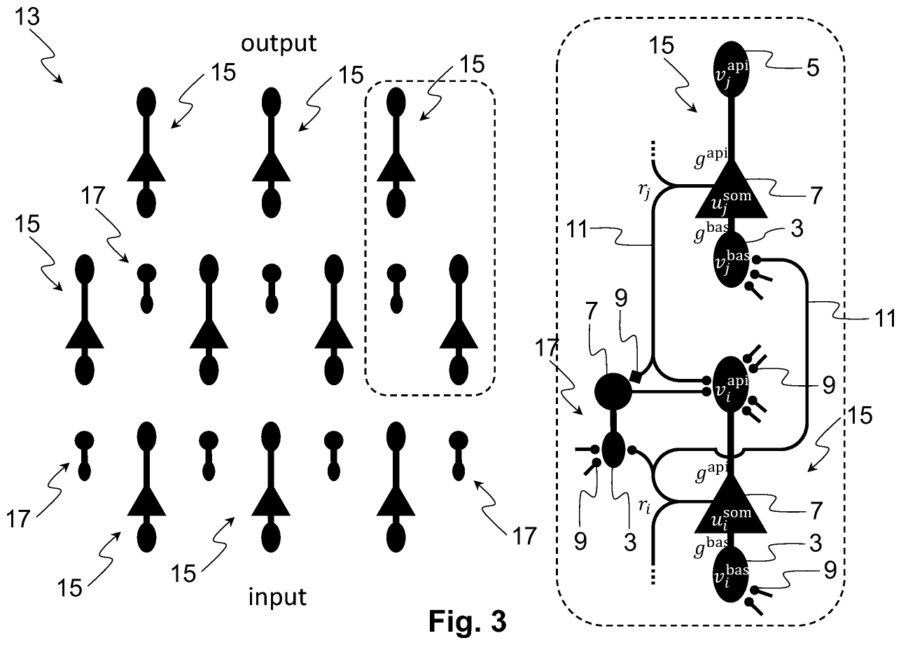

The fundamental building block of the neural network 13 is a cortical microcircuit model consisting of pyramidal cells 15 or neurons and interneurons 17 as shown in FIG. 3. The microcircuit is shown on the right in FIG. 3 in a more detailed manner, and the entire network, consisting of microcircuits, is on the left. Pyramidal cells 15 consist of three compartments: a basal dendrite 3 receiving bottom-up input from lower areas, an apical dendrite 5 receiving top-down input from higher areas and lateral input from interneurons 17, and a somatic compartment 7 that integrates dendritic information and generates the neuronal output. Interneurons 17 consist of two compartments: a basal dendrite 3 receiving input from pyramidal cells 15 in the same layer, and a somatic compartment 7 that receives input from pyramidal cells 15 in higher layers. The pyramidal cells are thus three-compartment neurons, while the interneurons are two-compartment neurons. Pyramidal somatic compartments 7 are leaky integrators of input from neighbouring compartments:

$${C}_{m} {\dot{u}}_{i}^{som} = {g}_{l} ( {E}_{l} - {u}_{i}^{som} ) + {g}^{bas} ( {v}_{i}^{bas} - {u}_{i}^{som} ) + {g}^{api} ( {v}_{i}^{api} - {u}_{i}^{som} ) , \qquad ( 6 )$$

where i is the neuron index, Eₗ the leak potential, vᵢ^{bas} and vᵢ^{api} the basal and apical membrane potentials, respectively, and g^{bas} and g^{api} the dendro-somatic couplings. Due to the conductance-based interaction between compartments, the effective time constant of the soma is τ^{s}: =Cₘ/(gₗ+g^{bas}+g^{api}). For somatic membrane potentials, assuming that apical dendrites encode errors (see below) and basal dendrites represent the input, this corresponds directly to Equation 3. Plasticity in basal synapses is driven by the local error signal given by the discrepancy between somatic and dendric membrane potentials uᵢ^{som} and vᵢ^{bas}:

$${\dot{ω}}_{ij} = {η}_{w} [ φ ( {u}_{i}^{som} ) - φ ( α {v}_{i}^{bas} ) ] φ ( {u}_{j}^{som} ) , \qquad ( 7 )$$

which is analogous to Equation 5 up to a monotonic transformation on the voltages.

In this architecture, plasticity serves two purposes. For pyramidal-to-pyramidal feedforward synapses 9, it implements error-correcting learning as a time-continuous approximation of BP. For pyramidal-to-interneuron synapses 9, it drives interneurons 17 to mimic their pyramidal partners 15 in the layers above. Thus, in a well-trained network, apical compartments 5 of pyramidal cells 17 are at rest, reflecting zero error, as top-down and lateral inputs cancel out. When an output error propagates through the network 13, these two inputs can no longer cancel out and their difference represents the local error eᵢ. This architecture does not rely on the transpose of the forward weight matrix, improving viability for implementation in distributed asynchronous systems. Here, we keep feedback weights fixed, realising a variant of feedback alignment. In principle, these weights could also be learned in order to further improve the local representation of errors.

Incorporating the principles of LE is straightforward and requires only that neurons fire prospectively: φ(u)→φ(ǔ^{eff}). While we have already addressed the evidence for prospective neuronal activity, we note that our plasticity also uses these prospective signals, which constitutes an interesting prediction for future in-vivo experiments.

The proposed microcircuit model can learn perfect classification even for very short presentation times. In contrast, traditional models without the prospective mechanism stagnate at high error rates even for this simple task. This can be traced back to the learning process being disrupted during relaxation. Without prospective dynamics, traditional models require presentation times on the order of 100τ^{eff} to achieve perfect accuracy. In contrast, LE only degrades for presentation times below 0.1τ^{eff}, which is due to the limited resolution of our numerical integration method. Thus, incorporating LE into cortical microcircuits can bring the required presentation times into biologically plausible regimes, allowing networks to deal with rich sensory data.

### Robustness to Substrate Imperfections

Computer simulations often assume perfectly homogeneous parameters across the network. Models can hence inadvertently rely on this homogeneity, resulting in unpredictable behaviour and possibly fatal dysfunction when faced with the physics of analogue substrates which are characterised by both heterogeneity in their components as well as temporal perturbation of their dynamics. Therefore, we consider robustness to spatio-temporal noise to represent a necessary prerequisite for any mathematical model aspiring to physical implementation, be it biological or artificial.

Spatial noise reflects the individuality of cortical neurons or the heterogeneity arising from device mismatch in hardware. Here, we focus on the heterogeneity of time constants; in contrast to, for example, variability in synaptic parameters or activation functions, these variations cannot be “trained away” by adapting synaptic weights. The two time constants that govern neuron dynamics in our model, namely integration (Equation 3) and prospective coding (Equation 1), previously assumed to be identical, are affected independently by such variability. To differentiate between the two, we assign the prospective dynamics their own time constant: ǔ^{r}:=u+τ^{r}\dot{u}. We can now model heterogeneity as independent, multiplicative Gaussian noise on all time constants: τ^{m/r}→(1+ξ) τ^{m/r}, with ξ˜ [symbol] (0, σ_{τ}²); we use multiplicative noise to emphasise that our model is agnostic to absolute time scales, so only relative relationships between specific time constants matter.

Due to the resulting mismatches between the timing of neuronal input and output, neuronal outputs suffer from exponential transients, leading to relaxation issues similar to the ones we already addressed in detail. However, depending on the transmission of top-down signals, the effects on learning performance can be very different. According to the formal theory, backward errors use the correct prospective voltages: e∝[ǔ^{m}−Wφ(ǔ^{r})] (Equations 4 and 5); this allows robust learning even for relatively large perturbations in the forward signals. In contrast, in biophysical implementations such as the microcircuits discussed above, neurons can only transmit a single output signal φ(ǔᵢ^{r}), which consequently also affects the errors: e∝[ǔ^{r}−Wφ(ǔ^{r})]. Since deviations due to a mismatch between integration and prospective time constants persist on the time scale of τ^{m}, even small amounts of mismatch can lead to a significant loss in performance.

Here we address this issue by introducing a neuron-local adaptation mechanism that corrects the difference between prospective voltages ǔ^{m} and ǔ^{r} induced by mismatching time constants:

$${\dot{τ}}^{m} = {η}_{τ} ( {{u}^{⋁}}^{r} - Wr - b ) \dot{u} . \qquad ( 8 )$$

In biological substrates, this could, for example, correspond to an adaptation of the transmembrane ion channel densities, whereas on many neuromorphic substrates, neuronal time constants can be adapted individually. Before training the network, we allow it to go through a “developmental phase” in which individual neurons are not affected by top-down errors and learn to match their prospective firing to their membrane dynamics, thus recovering the performance of networks with perfectly matched time constants. This developmental phase merely consists of presenting input samples to the network, for a duration that depends on the required matching precision. Here, we achieved mismatches below 1‰ within the equivalent of 20 training epochs. It is to be noted that, as observed, for example, in vivo, neuronal time constants remain diverse after this phase, but are matched in a way that enables fast reaction of downstream areas to sensory stimuli—an ability that is certainly helpful for survival.

We next model additive temporal noise on neuronal outputs as might be induced, for example, by noisy transmission channels: r→r+ξ, with ξ˜ [symbol] (0, σᵣ²). Formally, this turns membrane dynamics into a Langevin process. These perturbations add up over consecutive layers and can also accumulate over time due to recurrent interactions in the network. This introduces noise to the weight updates that can impair learning performance. Due to their slow integration of inputs, traditional neuron models filter out this noise, but our prospective mechanism effectively removes this filter. We thus optionally use an additional denoising mechanism, for which we again turn to biology: by introducing synaptic filtering with a short time constant τ^{s}, synaptic input is denoised before reaching the membrane; formally, r=φ(ǔ^{m}) is replaced by a low-pass-filtered r̅^{s} in the energy function (Equation 2). This narrow filter also mitigates possible numerical instabilities, as discussed in Section “Fast computation in slow substrates”.

Networks equipped with synaptic filters learn reliably even in the presence of significant noise levels. However, introducing this filter affects the quasi-instantaneity of computation in our networks, which then require longer input presentation times in the presence of synaptic filtering. Even so, these presentation times need only be “long” with respect to the characteristic time constant of relaxation mismatches—in this case, τ^{s}. Thus, for the typical scenario of white noise described above, minuscule τ^{s} on and even below biological time scales can achieve effective denoising, without significantly affecting the advantages conferred by prospective coding. In conclusion, the demonstrated robustness of our model (to spatial and temporal substrate imperfections) introduced by simple, biologically inspired mechanisms, make it a promising candidate for implementation in analogue physical systems.

A new framework was introduced above for inference and learning in physical systems composed of computational elements with finite response times. Our model rests on four simple axioms: prospective coding (Equation 1), neuronal mismatch energy (Equation 2), energy conservation under neuronal dynamics (Equation 3) and gradient descent on the energy under synaptic plasticity (Equation 5). In particular, incorporating the simple, biologically inspired mechanism of prospective coding allows us to avoid critical issues and scalability bottlenecks inherent to many current models of approximate BP in cortex. Furthermore, the resulting implementations can be made robust to substrate imperfections, a prerequisite for deployment in analogue neuronal systems, both biological and artificial.

Our framework carries implications both for neuroscience and for the design of neuromorphic hardware. The prospective mechanism described here would allow biological circuits to respond much faster than previously assumed. Furthermore, our framework suggests that both inference and learning take place on prospective, rather than instantaneous neuronal quantities. From a hardware perspective, this lifts the previously perceived limitations of slow analogue components (as compared to digital ones) without relinquishing their power efficiency.

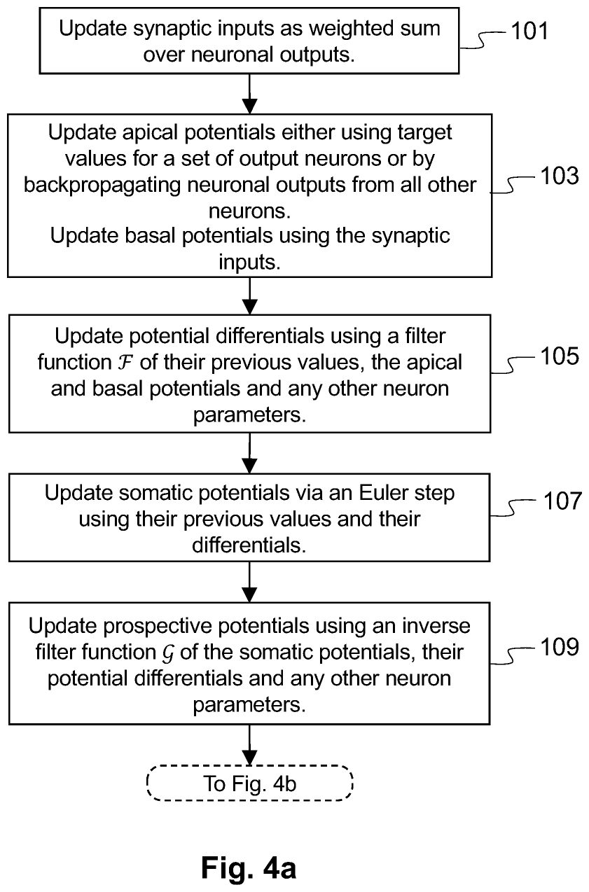

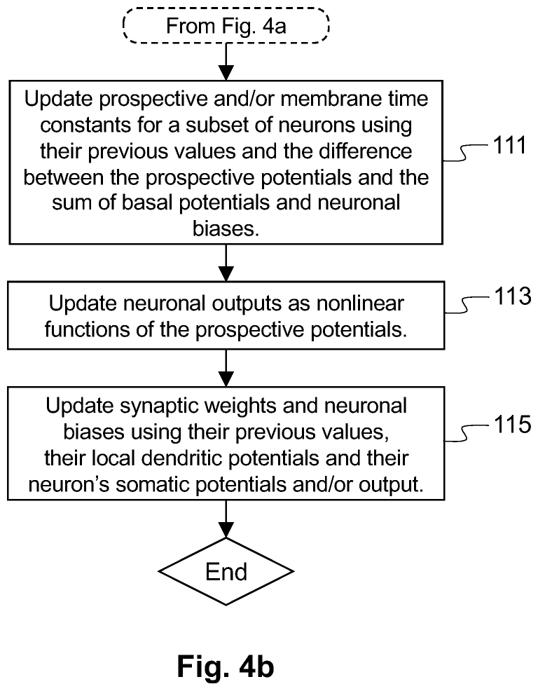

The flowchart of FIGS. 4a and 4b summarises the method of processing signals according to a generic concept in a neural network comprising a set of neurons 1 interconnected by a set of synapses 9, where a neuron 1 comprises a basal dendrite 3, a soma 7, and an apical dendrite 5. In this example, the method steps are carried out for each time t (with time steps Δt), and the operations in a given step are carried out for all neurons k from 1 to N. The operations in a given step can be carried out sequentially or in parallel. In the equations below, “·” and “/” denote component-wise products and divisions.

In step 101, the synaptic inputs (i.e. the synaptic input signals) are updated, i.e. s(t)←W(t−Δt)r(t−Δt). In other words, the synaptic inputs are updated so that they become equal to a weighted sum over neuronal outputs (i.e. neuronal output signals). Thus, these updated synaptic inputs for a given neuron depend on a synaptic weight vector multiplied by a corresponding presynaptic signal vector. Optionally, if in this step a synaptic filter is applied e.g. according to the teachings of section “Robustness to substrate imperfections”, then s(t)←(τ^{s})⁻¹·[−s(t−Δt)+W(t−Δt)r(t−Δt)]. Multiple operations in this step can be carried out in parallel. It is to be noted that when a signal, an item or any value more generally is updated, the outcome is an updated signal, item or value even if this is not explicitly stated in this context.

In step 103, apical and basal potentials of the neurons 1 are updated. More specifically, the apical potentials are updated either using target values for a set of output neurons or by backpropagating the neuronal outputs from all other neurons. The basal potentials are updated using the updated synaptic inputs. In other words, u^{a}(t)←e^{tgt}(t) if k∈O, where tgt denotes the target, O denotes the set of output neurons, and u^{a}(t)←φ′(ŭ^{r}(t−Δt))·W^{T}(t−Δt) [ŭ^{r}(t−Δt)−s(t)] otherwise, and u^{b}(t)←s(t). Multiple operations in this step can be carried out in parallel. One apical potential and one basal potential are updated per neuron. It is to be noted that the teachings of the present invention are also applicable even if only one or two of the three update processes takes place in steps 101 and 103.

In step 105, potential differentials of the neurons 1 are updated (one potential differential per neuron). More specifically, potential differentials are updated using a filter function [symbol] of their previous values, the apical and basal potentials and optionally any other neuron parameters. In other words, Δu(t)← [symbol] (u(t−Δt), u^{a}(t), u^{b}(t)|W(t−Δt), b(t−Δt), τ^{m}(t−Δt), . . . ). If no apical and/or basal potentials are updated in step 103, then the respective potential differential is updated by using at least a respective updated synaptic input signal.

In step 107, somatic potentials of the neurons 1 (one somatic potential per somatic compartment, i.e. per neuron) are updated. More specifically, the somatic potentials are updated via an Euler step using their previous values and their differential, in other words u(t)←u(t−Δt)+Δt Δu(t). Multiple operations in this step can be carried out in parallel.

In step 109, prospective potentials of the neurons (one prospective potential per neuron) are updated, which is also one of the main contributions of the present invention. More specifically, the prospective potentials are updated using an inverse filter function [symbol] of the somatic potentials, their potential differentials and optionally any other neuron parameters. This means that ŭ^{r}(t)← [symbol] (u(t), Δu(t)|τ^{r}(t−Δt), . . . ).

Then optionally in step 111 and before training, time constants are updated for a subset of neurons or all of the neurons. More specifically, prospective and/or membrane time constants for a subset of neurons are updated using their previous values and the difference between the prospective potentials and the sum of basal potentials and neuronal biases. In other words, for membrane time constants τm(t)←τm(t−Δt)+Δt ητ·[ŭ^{r}(t)−u^{b}(t)−b(t−Δt)], and for prospective time constants τ^{r}(t)←τ^{r}(t−Δt)−Δt η_{τ}·[ŭ^{r}(t)−u^{b}(t)−b(t−Δt)]. One aim would be to make the time constants τ^{m}(t) and τ^{r}(t) equal or substantially equal. Multiple operations in this step can be carried out in parallel.

In step 113, neuronal outputs (in this example one output signal per neuron) are updated. More specifically, neuronal outputs are updated as nonlinear functions of the prospective potentials. Accordingly, in this step, r(t)←φ(ŭ^{r}(t)). Multiple operations in this step can be carried out in parallel.

As soon as the above steps have been carried out for all the neurons or for the desired number of neurons, then the process can be terminated. Optionally, the process may be continued so that in step 115 synaptic plasticity is implemented. More specifically, the synaptic weights (one weight per synapse) and neuronal biases (one bias per neuron) are updated using their previous values, their local dendritic potentials and their neuron's somatic potentials and/or output. For example, the synaptic weights can now be updated during training as follows: W(t)←W(t−Δt)+Δt η_{W}·u^{a}(t) r^{T}(t) (the apical potential being the difference between the somatic and the basal potentials). Similarly, the neuronal biases can now be updated during training: b(t)←b(t−Δt)+Δt η_{b}·u^{a}(t). Multiple operations in this step can be carried out in parallel.

The flowchart of FIGS. 4a and 4b illustrate a generic scenario for implementing the teachings of the present invention. According to a first special case, the network uses leaky integrators. In this case, step 105, where the potential differentials are updated, can be written as Δu(t)←[τ^{m} (t−Δt)]⁻¹·[−u(t−Δt)+u^{b}(t)+u^{a}(t)+b(t−Δt)], while step 109, where the prospective potentials are updated, can we written as ŭ^{r}(t)←u(t)+τ^{r}(t−Δt)·Δu(t), which corresponds to Equation 1 assuming τ^{r} equals τ^{m}.

According to a second special case, the network uses harmonic oscillators. In this case, step 105 can be divided into two sub-steps. More specifically, first 2^{nd} order potential differentials are updated: Δ²u(t)←−ku(t−Δt)+u^{b}(t)+u^{a}(t)+b(t−Δt). Subsequently, 1^{st} order potential differentials are updated: Δu(t)←Au(t−Δt)+Δt Δ²u(t). According to the second special case, the prospective potentials are updated in step 109 in the following manner: ŭ^{r}(t)←k·u(t)+Δ²u(t).

According to a third special case, the network uses neuronal cables. According to this case, the potential differentials are updated in step 105 as follows: Δu(t)←[τ^{m}(t−Δt)]⁻¹·[−u(t−Δt)+u^{b}(t)+u^{a}(t)+b(t−Δt)−λi^{m}(t)]. Furthermore, according to the third special case, the prospective potentials are updated in step 109 as follows: ŭ^{r}(t)←u(t)+τ^{r}(t−Δt)·Δu(t)−λi^{m}(t).

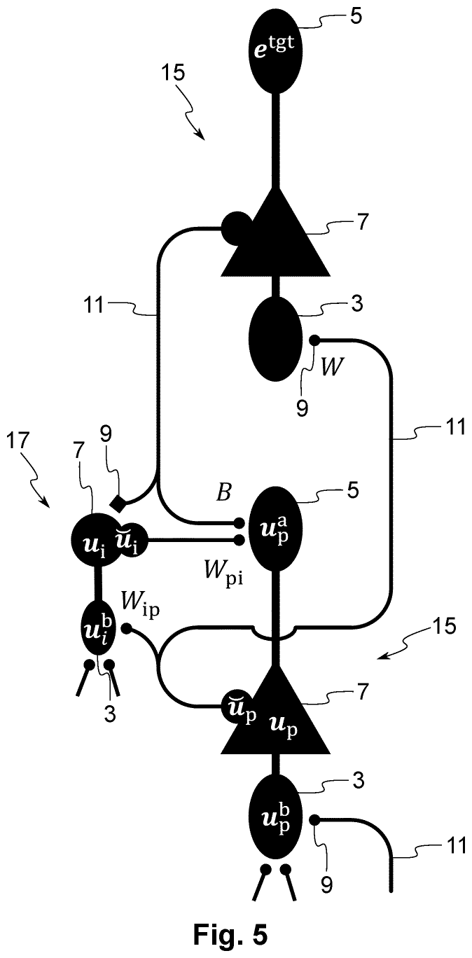

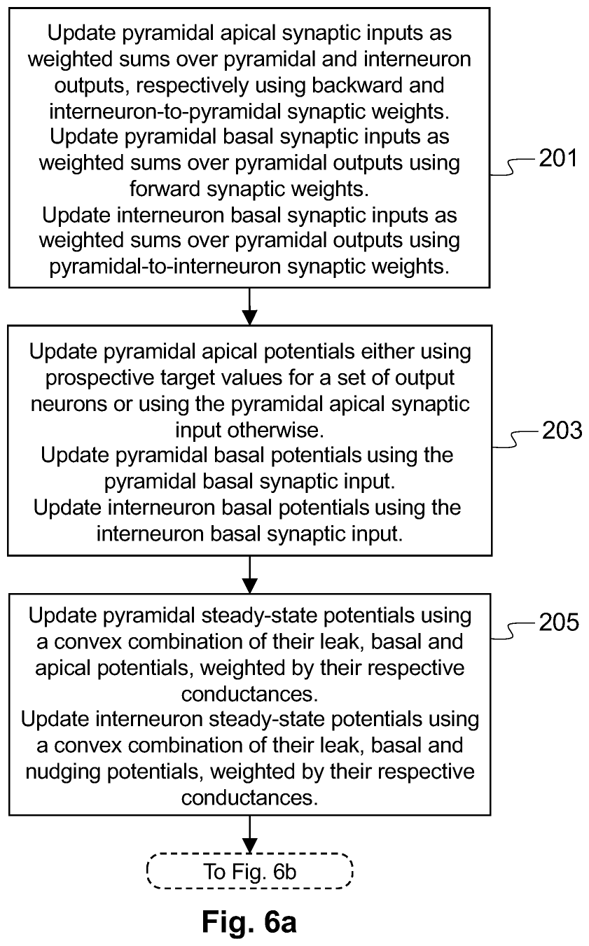

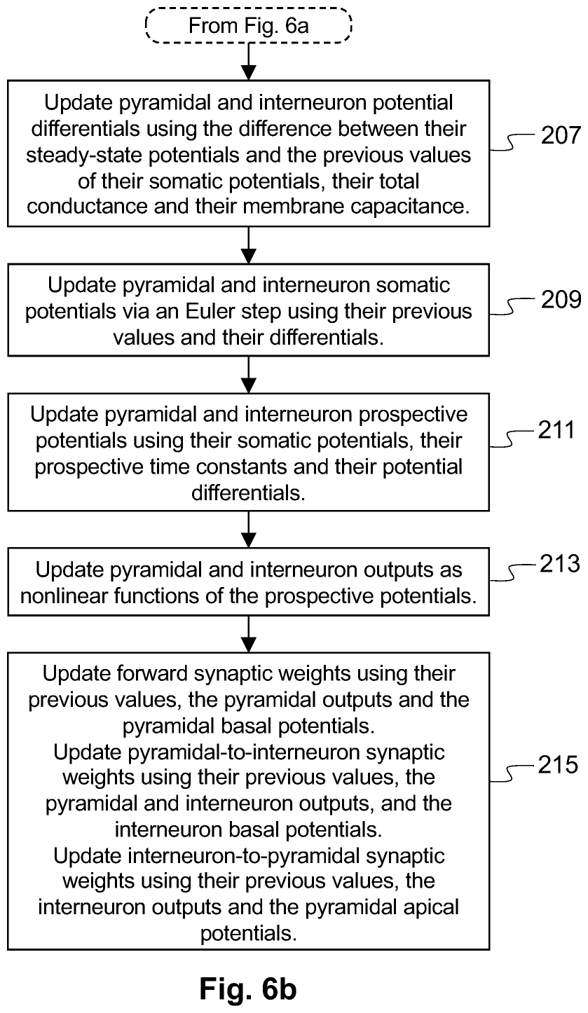

An example process of running the proposed method in a cortical microcircuit is next explained in more detail with reference to FIG. 5 and the flowchart of FIGS. 6a and 6b. In this example, the steps are carried out for each time t (with time steps Δt), and the operations in a given step are carried out for all neurons k from 1 to N. The operations in a given step can be carried out sequentially or at least some of them can be carried out in parallel. In step 201, synaptic inputs are updated. More specifically, pyramidal apical synaptic inputs are updated as weighted sums over pyramidal and interneuron outputs, respectively using the backward and interneuron-to-pyramidal synaptic weights, sₚ^{a}(t)←Wₚᵢ(t−Δt) rᵢ(t−Δt)+Brₚ(t−Δt). Pyramidal basal synaptic inputs are updated as weighted sums over pyramidal outputs using the forward synaptic weights, sₚ^{b}(t)←W(t−Δt) rₚ(t−Δt). Interneuron basal synaptic inputs are updated as weighted sums over pyramidal outputs using the pyramidal-to-interneturon synaptic weights, sᵢ^{b}(t)←Wᵢₚ(t−Δt)rₚ(t−Δt). Multiple operations in this step can be carried out in parallel.

In step 203, dendritic potentials (one potential per compartment) are updated. More specifically, pyramidal apical potentials are updated either using prospective target values for a set of output neurons or using the pyramidal apical synaptic input otherwise, uₚ^{a}(t)←ŭ_{tgt}^{r}(t) if k∈O, where O denotes the set of output neurons, uₚ^{a}(t)←sₚ^{a}(t) otherwise. Pyramidal basal potentials are updated using the pyramidal basal synaptic input, uₚ^{b}(t)←sₚ^{b}(t). Interneuron basal potentials are updated using the interneuron basal synaptic input, uᵢ^{b}(t)←sᵢ^{b}(t). Multiple operations in this step can be carried out in parallel.

In step 205, steady-state potentials (one steady-state potential per neuron) are updated. More specifically, pyramidal steady-state potentials are updated using a convex combination of their leak, basal and apical potentials, weighted by their respective conductances, uₚ^{eff}(t)←[gₗ·Eₗ+g_{b}·uₚ^{b}(t)+gₐ·uₚ^{a}(t)]/(gₗ+g_{b}+gₐ). Interneuron steady-state potentials are updated using a convex combination of their leak, basal and nudging potentials, weighted by their respective conductances, uᵢ^{eff}(t)←[gₗ·Eₗ+g_{b}·uᵢ^{b}(t)+g_{nudge}·ŭₚ^{r}(t−Δt)]/(gₗ+g_{b}+g_{nudge}). Multiple operations in this step can be carried out in parallel.

In step 207, potential differentials (one potential differential per neuron) are updated. More specifically, pyramidal and interneuron potential differentials are updated using the difference between their steady-state potentials and the previous values of their somatic potentials, their total conductance and their membrane capacitance. In other words, pyramidal differentials are updated as follows: Δuₚ(t)←[uₚ^{eff}(t)−uₚ(t−Δt)]·(gₗ+g_{b}+gₐ)/Cₘ, while the interneuron potential differentials are updated as follows: Δuᵢ(t)←[uᵢ^{eff}(t)−uᵢ(t−Δt)]·(gₗ+g_{b}+g_{nudge})/Cₘ.

In step 209, somatic potentials (one somatic potential per somatic compartment) are updated. More specifically, pyramidal and interneuron somatic potentials are updated via an Euler step using their previous values and their differentials. In other words, pyramidal somatic potentials are updated as follows: uₚ(t)←uₚ (t−Δt)+Δt Δuₚ(t), while the interneuron somatic potentials are updated as follows: uᵢ(t)←uᵢ(t−Δt)+Δt Δuᵢ(t). Multiple operations in this step can be carried out in parallel.

In step 211, prospective potentials (one prospective potential per neuron) are updated. More specifically, pyramidal and interneuron prospective potentials are updated using their somatic potentials, their prospective time constants and their potential differentials. In other words, the pyramidal prospective potentials are updated as follows: ŭₚ^{r}(t)←uₚ(t)+τₚ^{r}(t−Δt)·Δuₚ(t), while the interneuron prospective potentials are updated as follows: ŭᵢ^{r}(t)←uᵢ(t)+τᵢ^{r}(t−Δt)·Δuᵢ(t).

In step 213, neuronal outputs (in this example one output signal per neuron) are updated. More specifically, pyramidal and interneuron outputs are updated as nonlinear functions of the prospective potentials. In other words, the pyramidal outputs are updated as follows: rₚ(t)←φ(ŭₚ^{r}(t)), while the interneuron outputs are updated as follows: rᵢ(t)←φ(ŭᵢ^{r}(t)). Multiple operations in this step can be carried out in parallel.

In step 215, synaptic weights (one weight per synapse) are updated. More specifically, forward synaptic weights are updated using their previous values, the pyramidal outputs and the pyramidal basal potentials, W(t)←W(t−Δt)+Δt η_{W}·[rₚ^{T}(t)−φ(α·uₚ^{b}(t))]rₚ^{T}(t). Pyramidal-to-interneuron synaptic weights are updated using their previous values, the pyramidal and interneuron outputs, and the interneuron basal potentials, Wᵢₚ(t)←Wᵢₚ(t−Δt)+Δt ηᵢₚ·[rᵢ^{T}(t)−φ(α·uᵢ^{b}(t))] rₚ^{T}(t). Interneuron-to-pyramidal synaptic weights are updated using their previous values, the interneuron outputs and the pyramidal apical potentials, Wₚᵢ(t)←Wₚᵢ(t−Δt)+Δt ηₚᵢ·[−uₚ^{a}(t)]rᵢ^{T}(t).

The flowcharts described above have two interpretations—one as an algorithm, the other as dynamical equations for physical systems. The proposed algorithm is suitable to undo neuronal filtering and enable quasi-instantaneous information propagation, and this can be achieved in physical systems that obey our proposed dynamics. The method steps described above may be carried out by suitable circuits or circuitry when the process is implemented in hardware or using hardware for individual steps. However, the method may also be implemented in software using an artificial neural network comprising artificial neurons and artificial synapses. The terms “circuits” and “circuitry” refer to physical electronic components or modules (e.g. hardware), and any software and/or firmware (“code”) that may configure the hardware, be executed by the hardware, and or otherwise be associated with the hardware. The circuits may thus be operable (i.e. configured) to carry out or they comprise means for carrying out the required method steps as described above.

Since the proposed hardware implementation combines state-of-the-art computational capabilities with very low power consumption and a high degree of robustness to noise, the teachings of the present invention may be used for a large variety of edge-computing scenarios where energy and power supplies are strongly limited, such as small drones, spacecraft and, in particular, neuroprosthetics and bio-monitoring devices, both implanted and wearable. The products could be chips that can be connected to sensors and learn to perform particular tasks on their output data stream in real-time, such as navigation or diagnostics. It is to be noted that one key problem of existing neuromorphic hardware is the following dilemma: gain speed (often replacing analogue by digital circuits) but sacrifice power efficiency, or reduce the power consumption (using analogue components, especially neurons) at the cost of reducing speed and increasing noise. It is believed that the proposed approach resolves this dilemma and can thus harness the best of both worlds on a mixed-signal substrate (analogue neuron and synapse dynamics, digital communication between neurons).

Some additional examples are briefly explained next, namely networks of harmonic oscillators, learning of backward weights, and temporal processing.

According to the case of networks of harmonic oscillators, each node in the network is a harmonic oscillator. As previously, we obtain the node dynamics from Duᵢ=Iᵢ where Iᵢ=uᵢ^{a}+uᵢ^{b}+bᵢ and D is the differential operator of a damped harmonic oscillator

$$D = \frac{{d}^{2}}{{dt}^{2}} + 2 {ζω}_{0} \frac{d}{dt} + {ω}_{0}^{2} \hat{} 2.$$

Here ζ and ω₀ are the dampening ratio and angular frequency constants, respectively. These determine the time scale τ=(πω₀)⁻¹ on which the oscillator reacts to input. The special case of the undamped harmonic oscillator is obtained for ζ=0.

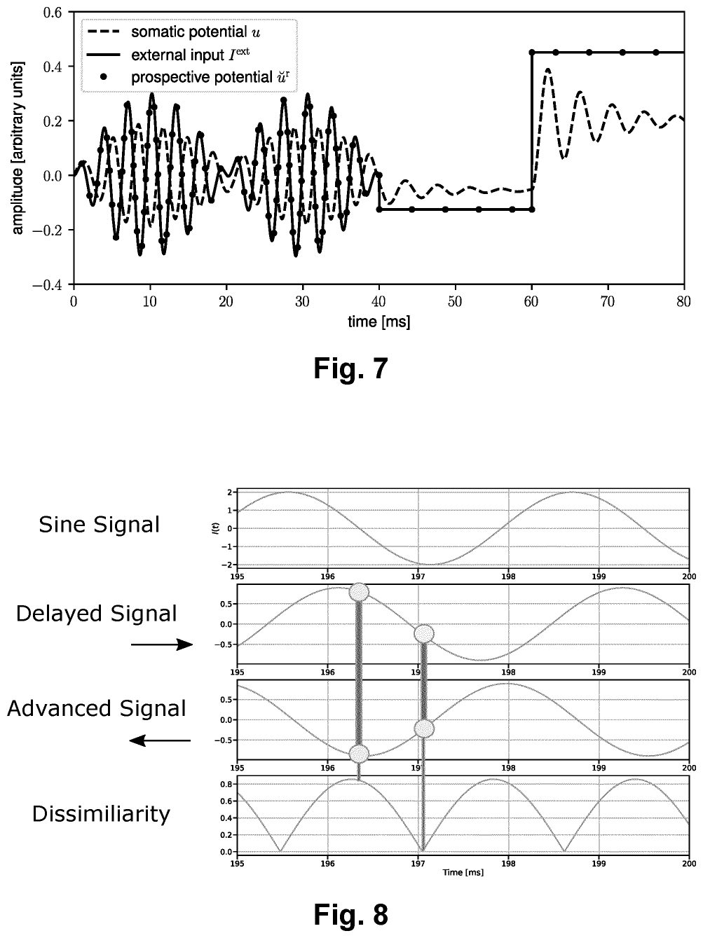

To illustrate this systems behaviour, we consider the somatic potential u and its prospective version ǔ=Du in the case of a quickly changing stimulus. The first part of the stimulus, i.e. the external input I^{ext} in FIG. 7, is comprised of a high-frequency sinewave, while the second part contains a discrete step (FIG. 7). The somatic potential (dashed line) corresponds to a combination of the input signal and the intrinsic dynamics of the oscillator. On the level of the prospective potential ǔ=Du we recover the stimulus, thus demonstrating quasi-instantaneous activity propagation via nodes with complex internal dynamics.

As far as the example of learning of backward weights is concerned, to support successful learning in hierarchical networks of many layers, backward weights B need to propagate errors correctly. In the ideal case, they correspond to the transpose of the forward weight matrix B=W^{T}. Under these conditions (and in the limit of weak target signals) the algorithm implements the error backpropagation algorithm. However, in physical substrates with time-continuous dynamics such a requirement is difficult to realize due to locality of information.

Using the proposed method, it is possible to learn useful backward weights in dynamical systems. To achieve this, at each hidden layer, Ornstein-Uhlenbeck noise ξₗ is added to the somatic potential uₗ. Output rates, calculated from these noisy somatic potentials, are then transmitted to the subsequent layer. At every backward synapse B_{l,l+1} a high-pass filtered rate [symbol] is computed which extracts the noise signal. Backward weights are then adjusted according to B_{l,l+1}= [symbol] −αB_{l,l+1}. This algorithm approximately aligns the backward weights with the transpose of the forward weights.

Fundamentally, this algorithm relies on a separation of signal and noise in frequency space. It is thus essential that all frequency components can propagate through the network uninhibited. Without the proposed method, each node in the network would introduce a low-pass filter, thus making the learning of backward weights via this algorithm infeasible.

To illustrate the differences between optimal backward weights, fixed, random backward weights and our algorithm to learn backward weights, we consider learning of representations in the bottleneck of an autoencoder trained on hand-written digits. The bottleneck comprises only two units for which we can visualize their activity for all data samples. While optimal and learned backward weights lead to representations in which different digits are approximately separated, fixed, random backward weights fail to learn such separated representations.

The case of temporal processing is explained next. The proposed method leads to instantaneous reactions of network activity to stimulus changes. This implies that network outputs are constrained to compute with instantaneous stimulus values only. In general, however, a task may require the network to make use of past and present stimulus information to determine its output.

We consider an extension of the proposed method in which we decouple the integration and prospective time constants, i.e., the differential operator becomes

$$D = {τ}_{m} \frac{d}{dt} + 1 ,$$

while the prospective membrane potential is computed as ǔ=u+τᵣ\dot{u}. In the case of a pure sinusoidal stimulus driving a neuron with different integration and prospective time constants, the neuron's output experiences both a modulation of the amplitude as well as a phase shift compared to the stimulus. The phase shift illustrates that decoupling the integration and prospective time constants indeed allows the neuron to use delayed or advanced stimuli to compute its output. This enables a population of neurons with different ratios of integration and prospective time constants to transform temporal information in a stimulus into spatial information across a population of neurons. This decoupling of time constants thus extends the ability of the proposed method to signal processing in the temporal domain.

We demonstrate the temporal processing capabilities of a network containing such neurons by computing a continuous-time analogue of the exclusive-or (XOR) operation. We provide a layer of neurons with mismatched time constants with a pure sinusoid. From this population, which contains information about present as well as past stimulus values, a network consisting of two layers of instantaneous neurons computes the mismatch between the original stimulus and a time-shifted version thereof. Indeed, if the ratio of integration and prospective time constants in the first layer is chosen correctly, this network learns to correctly map the stimulus input to the target values (FIG. 8).

To summarise the above teachings, the present invention according to one example concerns a method of processing signals in a neural network comprising a set of neurons interconnected by a set of synapses, with each neuron comprising a soma and optionally a set of apical and/or basal dendrites. The method comprises: updating at least one synaptic input signal configured to be received at input nodes of one or more neurons, and/or updating the corresponding basal potential of at least one of the basal dendrites, and/or updating the corresponding apical potential of at least one of the apical dendrites; updating a potential differential for at least one neuron by using the corresponding synaptic input signal, and/or the updated apical potential and/or the updated basal potential; updating the somatic potential of at least one of the somas by using at least the corresponding updated potential differentials; updating the prospective potential of at least one neuron by using at least the corresponding updated somatic potentials and potential differentials; and generating a neuronal output signal for at least one neuron by using the corresponding updated prospective potentials.

While the invention has been illustrated and described in detail in the drawings and foregoing description, such illustration and description are to be considered illustrative or exemplary and not restrictive, the invention being not limited to the disclosed embodiment. Other embodiments and variants are understood, and can be achieved by those skilled in the art when carrying out the claimed invention, based on a study of the drawings, the disclosure and the appended claims. New embodiments may be obtained by combining any of the teachings above.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the invention.

1. A method of processing signals in a neural network comprising a set of neurons interconnected by at least a set of synapses, a respective neuron comprising at least a soma, the method comprising:
updating one or more synaptic input signals configured to be received at one or more input nodes of a respective neuron to obtain updated synaptic input signals, and/or updating a respective basal potential of a respective basal dendrite of a respective neuron to obtain updated basal potentials, and/or updating a respective apical potential of a respective apical dendrite of a respective neuron to obtain updated apical potentials;
updating a respective potential differential of the respective neuron to obtain updated potential differentials such that the respective potential differential is updated by using at least a respective updated synaptic input signal, and/or at least a respective updated apical potential of the respective neuron, and/or a respective updated basal potential of the respective neuron;
updating a respective somatic potential of at least one of the somas to obtain updated somatic potentials by using at least a respective updated potential differential of the respective neuron for which the potential differential was updated;
updating a respective prospective potential of at least the respective neuron to obtain updated prospective potentials by using at least a respective updated somatic potential and the respective updated potential differential of the respective neuron; and
generating a respective neuronal output signal for the respective neuron by using at least a respective updated prospective potential of the respective neuron.

2. A method according to claim 1, wherein the one or more synaptic input signals are updated as weighted sums over neuronal output signals received from one or more other neurons in the neural network.

3. A method according to claim 1, wherein the method further comprises denoising the one or more synaptic input signals by a denoising mechanism.

4. A method according to claim 1, wherein the apical potentials are updated by either using target values for a set of output neurons of the neural network or by backpropagating neuronal output signals from one or more other neurons, and the basal potentials are updated by using the updated synaptic input signals.

5. A method according to claim 1, wherein the potential differentials are updated by using a filter function [symbol] of at least a previous value of the respective potential differential, and the respective updated apical and basal potentials.

6. A method according to claim 1, wherein the respective somatic potentials are updated via an Euler step using a previous value of the respective somatic potential and the respective updated potential differential.

7. A method according to claim 1, wherein the prospective potentials are updated by using an inverse filter function [symbol] of at least the respective updated somatic potential, and the respective updated potential differential.

8. A method according to claim 1, wherein the neuronal output signals are updated as a nonlinear function of the respective updated prospective potential.

9. A method according to claim 1, wherein the method further comprises updating respective prospective and/or membrane time constants for a subset of neurons by using previous values of the respective prospective and/or membrane time constants, and the difference between the respective updated prospective potential and the sum of the respective updated basal potential and a respective neuronal bias.

10. A method according to ceding-claim 1, wherein the method further comprises updating synaptic weights and/or neuronal biases by using at least their previous values, and the respective updated apical potential.

11. A method according to claim 1, wherein the neural network comprises a cortical microcircuit, wherein the set of neurons comprise a set of pyramidal neurons (and a set of interneurons, wherein a respective pyramidal neuron consists of a pyramidal basal dendrite receiving one or more bottom-up input signals from one or more hierarchically lower neurons, a pyramidal apical dendrite receiving one or more top-down input signals from one or more hierarchically higher neurons and one or more lateral input signals from one or more interneurons, and a pyramidal somatic compartment integrating dendritic information from a respective basal dendrite and a respective apical dendrite, and generating the respective neuronal output signal, and wherein a respective interneuron consists of an interneuron basal dendrite receiving one or more input signals from one or more pyramidal neurons in the same layer, and an interneuron somatic compartment receiving one or more input signals from one or more pyramidal neurons in hierarchically higher layers.

12. A method according to claim 11, wherein updating the one or more synaptic input signals comprises updating one or more pyramidal apical synaptic input signals, one or more pyramidal basal synaptic input signals, and one or more interneuron basal synaptic input signals, wherein updating the respective apical potential comprises updating a respective pyramidal apical potential, and updating the respective basal potential comprises updating a respective pyramidal basal potential and a respective interneuron basal potential, and wherein the method further comprises updating a respective pyramidal steady-state potential and a respective interneuron steady-state potential of the respective neuron.

13. A method according to claim 11, wherein updating the respective potential differential comprises updating a respective pyramidal differential and a respective interneuron potential differential, updating the respective somatic potential comprises updating a respective pyramidal somatic potential and a respective interneuron somatic potential, updating the respective prospective potential comprises updating a respective pyramidal prospective potential and a respective interneuron prospective potential, and generating the respective neuronal output signal comprises generating a respective pyramidal neuronal output signal of the respective pyramidal neuron and a respective interneuron neuronal output signal of the respective interneuron.

14. A method according to claim 11, wherein the pyramidal somatic compartments operate as leaky integrators of input from neighbouring compartments.

15. A neural network comprising a set of neurons interconnected by at least a set of synapses, a respective neuron comprising at least a soma, the neural network being configured to perform operations comprising:
update one or more synaptic input signals configured to be received at one or more input nodes of a respective neuron to obtain updated synaptic input signals, and/or update a respective basal potential of a respective basal dendrite of a respective neuron to obtain updated basal potentials, and/or update a respective apical potential of a respective apical dendrite of a respective neuron to obtain updated apical potentials;
update a respective potential differential of the respective neuron to obtain updated potential differentials such that the respective potential differential is updated by using at least a respective updated synaptic input signal, and/or at least a respective updated apical potential of the respective neuron, and/or a respective updated basal potential of the respective neuron;
update a respective somatic potential of at least one of the somas to obtain updated somatic potentials by using at least a respective updated potential differential of the respective neuron for which the potential differential was updated;
update a respective prospective potential of at least the respective neuron to obtain updated prospective potentials by using at least a respective updated somatic potential and the respective updated potential differential of the respective neuron; and
generate a respective neuronal output signal for the respective neuron by using at least a respective updated prospective potential of the respective neuron.
